(19) United States
(12) Patent Application Publication
(10) Pub. No.: US 2025/0016902 A1
(43) Pub. Date: Jan. 9, 2025

(54) CONTROL DEVICE AND CONTROL METHOD FOR ELECTRON EMISSION DEVICE FOR X-RAY GENERATION

(71) Applicant: LG ELECTRONICS INC., Seoul (KR)

(72) Inventors: Youngsik KIM, Seoul (KR); Taehyung KIM, Seoul (KR); Sungeun LEE, Seoul (KR); Mikiko ITO, Seoul (KR)

(73) Assignee: LG ELECTRONICS INC., Seoul (KR)

(21) Appl. No.: 18/712,658

(22) PCT Filed: Nov. 24, 2021
(86) PCT No.: PCT/KR2021/017348

§ 371 Date: May 22, 2024

(51) Int. Cl. H05G 1/08; H05G 1/26

(52) U.S. Cl. CPC H05G 1/085; H05G 1/265

(57) ABSTRACT

The present invention relates to a device of controlling an electron emission device generating X-rays, the device comprising: an electron emission device including at least one of at least one cathode electrode, an anode electrode paired with the cathode electrode, and a gate electrode for controlling a current flowing through the anode electrode; a cathode current detection part for detecting a current flowing through the cathode electrode of the electrode emission device; a reference voltage generation part for generating a reference voltage; and a gate voltage control part which receives the reference voltage and a detection voltage of the cathode current detection part, determines a gate voltage for controlling the electron emission device so that the detection voltage of the cathode current detection part becomes equal to the reference voltage, and applies the determined gate voltage to the gate electrode of the electron emission device.

### TECHNICAL FIELD

The present disclosure relates to an electron emission device that generates X-rays, and relates to a control apparatus and a control method capable of maintaining a current of an anode electrode constant.

### BACKGROUND ART

In general, an electron emission device that generates X-rays is provided with a cathode electrode and an anode electrode to generate X-rays through a process of inducing and accelerating electrons emitted from the cathode electrode to the anode electrode where a high voltage is formed to collide with the anode electrode.

A current I_{A} of the anode electrode, which determines an amount of X-rays generated herein, can be determined by a difference between a current I_{CA} of the cathode electrode and a current flowing through the control electrode (gate electrode), that is, a gate current I_{G}. That is, the current I_{A} of the anode electrode can be adjusted based on the gate current I_{G}, and the generated amount of X-rays can be adjusted according to the current I_{A} of the anode electrode.

Meanwhile, the gate current can be determined according to a voltage between the gate electrode and the cathode electrode (hereinafter referred to as a gate-cathode voltage V_{GC}). In this case, when the gate-cathode voltage is above a voltage required for electron emission according to the electron emission characteristics of the cathode electrode, the electron emission device can be turned on so as to emit electrons from the cathode electrode. On the contrary, when the gate-cathode voltage is below the voltage required for electron emission according to the electron emission characteristics of the cathode electrode, the electron emission device can be turned off so as not to emit electrons from the cathode electrode.

Meanwhile, the electron emission device uses a high gate voltage. Therefore, once the gate voltage is determined, it is common to fix the determined gate voltage. Therefore, a typical control apparatus for an electron emission device is configured to control a voltage of the cathode electrode so as to form a voltage difference required for electron emission.

In this case, as the cathode voltage increases, the gate-cathode voltage can increase. Furthermore, when being above the voltage required for electron emission according to the electron emission characteristics of the cathode electrode, electrons can be emitted (turn-on). In this case, when the electron emission device is turned on, a gate current can be formed according to the anode current and the cathode current. Furthermore, when the anode current is constant, the cathode current and the gate current applied to the cathode electrode to form the gate-cathode voltage have a proportional relationship.

Meanwhile, the voltage required for electron emission, which is a characteristic of the electron emission device, can be different for each electron emission device. For example, in the case of an electron emission device with a low required voltage, electrons can be emitted even when a low gate-cathode voltage is formed, and in the case of an electron emission device with a not-so-low required voltage, electrons can be emitted only when a high gate-cathode voltage is formed.

However, electron emission devices typically constitute an array such that a plurality of electron emission devices are typically used together. Accordingly, a plurality of electron emission devices each having different characteristics (voltages required for electron emission) can be used together.

Therefore, in order to allow electrons to be emitted from all of the plurality of electron emission devices used together, the gate-cathode voltage can be determined based on a voltage required for the electron emission device with the highest voltage required for electron emission. Accordingly, even for an electron emission device having good performance capable of emitting electrons only at a low voltage, a higher voltage than necessary is applied to the cathode voltage, and therefore, there is a problem of causing an overall unnecessary increase in operating voltage. Such an unnecessary high voltage not only reduces the efficiency of the electron emission device but also causes high-voltage stress in the equipment, and thus there is a problem in that a protection design capable of protecting the electron emission device from high-voltage stress is required.

### DISCLOSURE OF INVENTION

### Technical Problem

The present disclosure aims to solve the foregoing and other problems, and an aspect of the present disclosure is to provide an electron emission device control apparatus capable of adjusting a gate voltage to adjust an anode current, which determines an amount of X-rays generated therefrom, and a method of controlling the same.

In addition, an aspect of the present disclosure is to provide an electron emission device control apparatus capable of adjusting a gate voltage to form a gate-cathode voltage according to the characteristics of an electron emission device so as to prevent an unnecessarily high gate-cathode voltage from being applied thereto, and a method of controlling the same.

### Solution to Problem

In order to achieve the foregoing and other objectives, according to an aspect of the present disclosure, an electron emission device control apparatus in accordance with an embodiment of the present disclosure can include an electron emission device including at least one cathode electrode, an anode electrode paired with the cathode electrode, and at least one gate electrode for controlling a current flowing through the anode electrode, a cathode current detector that detects a current flowing through the cathode electrode of the electron emission device, a reference voltage generator that generates a reference voltage, and a gate voltage controller that receives the reference voltage and the detection voltage of the cathode current detector, determines a gate voltage for controlling the electron emission device such that the detection voltage of the cathode current detector is equal to the reference voltage, and applies the determined gate voltage to the gate electrode of the electron emission device.

In one embodiment, the gate voltage controller can determine a voltage greater than the reference voltage by a gate-cathode voltage formed between the gate electrode and the cathode electrode as the gate voltage, wherein the gate-cathode voltage is a voltage threshold required for electron emission from the cathode electrode.

In one embodiment, the current flowing through the anode electrode can be a current corresponding to the reference voltage when the current flowing through the anode electrode and the current flowing through the gate electrode satisfy a preset condition.

In one embodiment, the control apparatus can further include a gate current detector for detecting a gate current flowing through the gate electrode in the electron emission device, wherein the gate voltage controller determines a gate voltage for controlling the electron emission device such that the detection voltage of the cathode current detector is equal to a sum of the reference voltage and a compensation voltage for the gate current, and the compensation voltage is determined according to a detection resistance Z_{ref} of the cathode current detector for the current flowing through the cathode electrode and a magnitude of the gate current.

In one embodiment, a gate voltage that causes the detection voltage of the cathode current detector to be equal to the sum of the reference voltage and the compensation voltage can be determined as a voltage greater than the detection voltage by a voltage that is a sum of the compensation voltage, a gate-cathode voltage formed between the gate electrode and the cathode electrode, and the detection voltage of the gate current detector.

In one embodiment, the current flowing through the anode electrode can be determined according to a magnitude of the reference voltage with respect to the detection resistance Z_{ref} of the cathode current detector.

In one embodiment, the cathode current detector and the gate current detector can each be any one of a hole sensor, a magneto impedance (MI) current sensor, and a current sensor that detects a voltage dropped by a shunt resistance as a current.

In one embodiment, the cathode current detector can further include an amplifier for amplifying a voltage applied to a detection resistance of the cathode current detector, wherein the gate voltage controller determines the gate voltage based on a detection voltage of the cathode current detector, which is detected based on a detection resistance relatively lowered by an amplification gain of the amplifier.

In order to achieve the foregoing and other objectives, according to an aspect of the present disclosure, a control method of an electron emission device control apparatus in accordance with the present disclosure can include detecting a cathode voltage corresponding to a current flowing through the cathode electrode, detecting a reference voltage, determining a gate voltage such that the cathode current detection voltage is equal to the reference voltage based on a gate-cathode voltage, which is a voltage between a gate electrode of the electron emission device and the cathode electrode, and the reference voltage, and applying the determined gate voltage to the electron emission device to control the electron emission device such that a current corresponding to the reference voltage flows through the cathode electrode as the gate-cathode voltage drops through the electron emission.

In one embodiment, the gate-cathode voltage can be a voltage threshold required for electron emission from the cathode electrode.

In one embodiment, a current flowing through an anode electrode of the electron emission device can be a current corresponding to the reference voltage when the current flowing through the anode electrode and a current flowing through the gate electrode satisfy a preset condition.

In one embodiment, the detecting of the reference voltage can further include detecting a gate current flowing through the gate electrode, wherein the determining of the gate voltage includes determining a gate voltage for controlling the electron emission device such that the cathode voltage is equal to a sum of a compensation voltage for the gate current and the reference voltage, and the compensation voltage is determined according to a magnitude of the gate current and a detection resistance Z_{ref} for detecting the cathode voltage from the cathode current.

In one embodiment, a gate voltage that causes the cathode voltage to be equal to the sum of the reference voltage and the compensation voltage can be determined as a voltage greater than the detection voltage by a voltage that is a sum of the compensation voltage, the gate-cathode voltage, and a detection voltage corresponding to the gate current.

In one embodiment, the detecting of the cathode voltage can further include amplifying a voltage applied to a detection resistance Z_{ref} for detecting a current flowing through the cathode electrode as the cathode voltage, wherein the determining of the gate voltage includes determining the gate voltage based on the cathode voltage detected based on the detection resistance relatively lowered by an amplification gain.

In one embodiment, a current flowing through an anode electrode of the electron emission device can be determined according to a magnitude of the reference voltage with respect to the detection resistance Z_{ref} for detecting a current flowing through the cathode electrode as the cathode voltage.

### Advantageous Effects of Invention

The effects of an electron emission device control apparatus and a method of controlling the apparatus according to an embodiment of the present disclosure will be described as follows.

According to at least one of the embodiments of the present disclosure, the present disclosure can use a metal-oxide-semiconductor field-effect transistor (MOSFET) device as a gate of the electron emission device, thereby allowing the electron emission device to be turned on at a lower gate voltage. Accordingly, the adjustment of a gate voltage can be facilitated to control an anode current through adjusting the gate voltage, thereby having an effect capable of adjusting the anode current to be constant without the need to control a cathode voltage.

In addition, the present disclosure can allow the anode current to be controlled through adjusting the gate voltage according to a gate-cathode voltage according to the characteristics of the electron emission device. Therefore, there is no need to apply an unnecessarily high cathode voltage, thereby having an effect capable of solving problems caused by the application of an unnecessary high voltage, such as unnecessarily high operating voltage and high voltage stress.

### BRIEF DESCRIPTION OF DRAWINGS

FIG. 1 is a block diagram showing a configuration of an electron emission device control apparatus according to an embodiment of the present disclosure.

FIG. 2 is a block diagram for explaining a configuration of an electron emission device control apparatus according to an embodiment of the present disclosure.

FIG. 3 is a flowchart showing an operation process in which an electron emission device control apparatus according to an embodiment of the present disclosure controls a gate voltage to control an anode current.

FIG. 4 is an exemplary diagram showing a circuit configuration example of a gate voltage controller that controls a gate voltage in an electron emission device control apparatus according to an embodiment of the present disclosure.

FIG. 5 is a conceptual diagram for explaining a configuration of an electron emission device control apparatus according to an embodiment of the present disclosure, which includes a configuration of compensating for a gate current when the gate current is greater than an anode current.

FIG. 6 is a flowchart showing an operation process in which the electron emission device control apparatus according to the embodiment of the present disclosure shown in FIG. 5 controls a gate voltage to control an anode current.

FIG. 7 is an exemplary diagram showing a circuit configuration example of a gate voltage controller that controls a gate voltage in the electron emission device control apparatus shown in FIG. 5.

FIG. 8 is an exemplary diagram showing another circuit configuration example of a gate voltage controller that controls a gate voltage in the electron emission device control apparatus shown in FIG. 5.

FIG. 9 is a conceptual diagram for explaining a configuration of an electron emission device control apparatus according to an embodiment of the present disclosure, which further includes an amplifier capable of amplifying a cathode current detection voltage.

FIG. 10 is an exemplary diagram showing an example of an anode current controlled in an electron emission device control apparatus according to an embodiment of the present disclosure, and an anode current controlled in a typical electron emission device control apparatus.

### MODE FOR THE INVENTION

It should be noted that technical terms used herein are merely used to describe specific embodiments, and are not intended to limit the present disclosure. Furthermore, a singular expression used herein includes a plural expression unless it is clearly construed in a different way in the context. A suffix “module” or “unit” used for elements disclosed in the following description is merely intended for easy description of the specification, and the suffix itself is not intended to have any special meaning or function.

As used herein, terms such as “comprise” or “include” should not be construed to necessarily include all elements or steps described herein, and should be construed not to include some elements or some steps thereof, or should be construed to further include additional elements or steps.

In addition, in describing technologies disclosed herein, when it is determined that a detailed description of known technologies related thereto can unnecessarily obscure the subject matter disclosed herein, the detailed description will be omitted.

Furthermore, the accompanying drawings are provided only for a better understanding of the embodiments disclosed herein and are not intended to limit technical concepts disclosed herein, and therefore, it should be understood that the accompanying drawings include all modifications, equivalents and substitutes within the concept and technical scope of the present disclosure. In addition, not only individual embodiments described below but also a combination of the embodiments can, of course, fall within the concept and technical scope of the present disclosure, as modifications, equivalents or substitutes included in the concept and technical scope of the present disclosure.

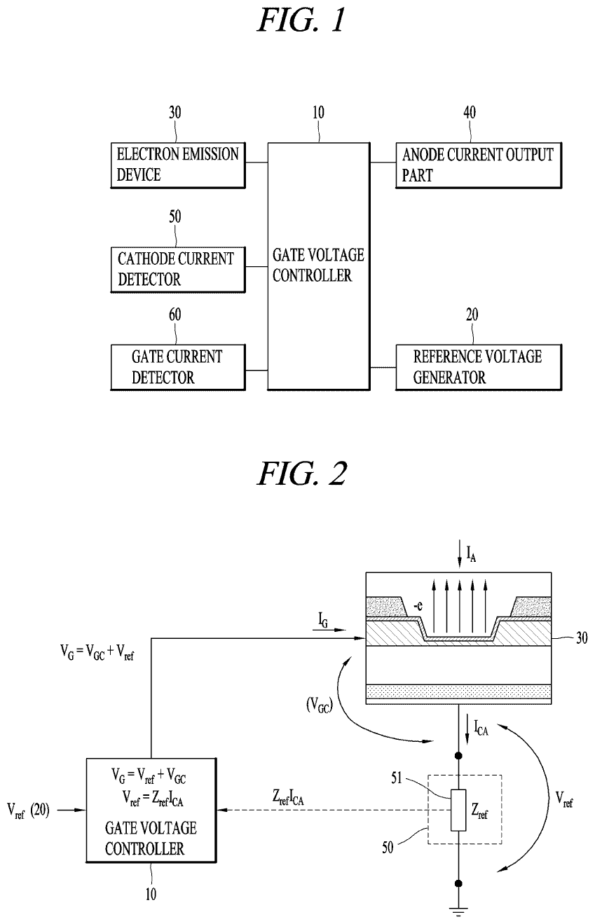

FIG. 1 is a block diagram showing a configuration of an electron emission device control apparatus according to an embodiment of the present disclosure.

Referring to FIG. 1, the electron emission device control apparatus according to an embodiment of the present disclosure can include a gate voltage controller 10, an electron emission device 30 connected to the gate voltage controller 10, a cathode current detector 50 for detecting a cathode terminal current (hereinafter referred to as a cathode current) of the electron emission device 30, and a reference voltage generator 20 that generates a reference voltage. Furthermore, a gate current detector 60 that detects a gate current applied to the electron emission device 30 and an anode current output part 40 that outputs a current (hereinafter referred to as anode current) applied to an anode electrode of the electron emission device 30 can be further connected to the gate voltage controller 10.

The elements shown in FIG. 1 are not essential for implementing an electron emission device control apparatus, and thus the electron emission device control apparatus described herein can have more or fewer components than those listed above.

More specifically, among the above elements, the electron emission device 30 can include at least one electron emission device. In case where the electron emission device 30 includes a plurality of electron emission devices, the plurality of electron emission devices can constitute an array.

Therefore, the electron emission device 30 can include at least one cathode electrode that emits electrons, and can include at least one anode electrode paired with the cathode electrode. Furthermore, the electron emission device 30 can include at least one gate electrode for controlling the flow of electrons moving between the cathode electrode and the anode electrode.

Here, a gate voltage determined by the gate voltage controller 10 can be applied to the gate electrode. Furthermore, the cathode electrode can emit electrons when a voltage difference between the cathode electrode and the gate electrode, that is, a gate-cathode voltage, exceeds a preset electron emission threshold. Furthermore, electrons emitted from the cathode electrode can be induced and accelerated by a high voltage applied to an anode electrode to collide with the anode electrode. Furthermore, X-rays can be generated through the collision of the electrons.

Here, since X-rays are generated by the collisions of electrons, an amount of X-rays generated is determined by a magnitude of the current rather than the voltage. That is, the amount of X-rays generated can be determined according to an anode current I_{A} applied to the anode electrode. Furthermore, the anode current I_{A} can be determined by a difference between a current I_{CA} of the cathode electrode and a current flowing out through the gate electrode, that is, a gate current I_{G}(I_{CA}=I_{A}+I_{G}). That is, the current I_{A} of the anode electrode can be adjusted according to the gate current I_{G}, and the amount of X-rays generated can be adjusted according to the current I_{A} of the anode electrode.

Furthermore, the cathode current detector 50 can detect a current applied to at least one cathode electrode of the electron emission device 30, that is, a current flowing out through the cathode electrode (hereinafter referred to as a cathode current). To this end, the cathode current detector 50 can include at least one current sensor to detect a current.

The cathode current detector 50 can include various sensors as a current sensor. For example, the cathode current detector 50 can include a hole sensor or a magneto impedance (MI) current sensor using a magnetic field impedance effect. Alternatively, for the current sensor, it can be provided with a current sensor that includes a shunt resistor to detect a voltage drop due to the shunt resistor as a current. In the following description, for the sake of convenience of explanation, an example in which the cathode current detector 50 detects the cathode current as a voltage detected using the shunt resistor will be described.

However, the present disclosure is not, of course, limited thereto, and a magnitude of the cathode current detected through the hole sensor or MI sensor can also, of course, be used. As an example, in the case of the hole sensor or MI sensor, the cathode current can be directly detected without a shunt resistance, and in this case, assuming that there is a resistance (e.g., 1 ohm) having a preset value, a cathode voltage corresponding to the detected cathode current can be determined.

Meanwhile, the gate voltage controller 10 can determine a gate voltage capable of maintaining the anode current of the electron emission device 30 constant and apply the determined gate voltage to the electron emission device 30. To this end, the gate voltage controller 10 can first detect the cathode current of the electron emission device 30 through the cathode current detector 50. Furthermore, a gate voltage that causes a voltage (cathode voltage) corresponding to the cathode current to be a reference voltage V_{ref} generated by the reference voltage generator 20 can be determined.

In this case, a difference between the gate voltage V_{G} and the cathode voltage V_{CA} forms a voltage required to emit electrons from the cathode electrode, that is, a gate-cathode voltage V_{GC}, so the gate voltage V_{G} that causes the cathode voltage V_{CA} to be the reference voltage V_{ref} can be a voltage greater than the reference voltage V_{ref} by the gate-cathode voltage V_{GC}.

That is, the gate voltage controller 10 can determine the gate-cathode voltage V_{GC}, determine the gate voltage V_{G} including the determined gate-cathode voltage V_{GC} and the reference voltage V_{ref}, and apply the determined gate voltage V_{G} to the electron emission device 30, thereby controlling the electron emission device 30 such that the cathode current I_{CA} corresponding to the reference voltage V_{ref} flows through the cathode electrode of the electron emission device 30.

In this case, assuming that the gate current I_{G} is sufficiently small compared to the anode current I_{A}, the cathode current I_{CA} becomes equal to the anode current I_{A}, and the cathode current I_{CA} has a current value corresponding to the reference voltage V_{ref}, so the anode current I_{A} can be controlled to be constant according to the reference voltage V_{ref}.

Hereinafter, the configuration of the electron emission device control apparatus according to an embodiment of the present disclosure, which can be applied in a case where the gate current I_{G} is sufficiently small compared to the anode current I_{A}, will be described in more detail with reference to FIGS. 2 to 4 below.

Meanwhile, when the gate current I_{G} is not sufficiently small compared to the anode current I_{A}, the cathode voltage V_{CA} can include a compensation voltage ΔV for the gate current I_{G}. Therefore, the gate voltage controller 10 can determine the gate-cathode voltage V_{GC}, determine the gate voltage V_{G} including the determined gate-cathode voltage V_{GC}, the reference voltage V_{ref}, and the compensation voltage ΔV, and apply the determined gate voltage V_{G} to the electron emission device 30, thereby controlling the electron emission device 30 such that the cathode current I_{CA} corresponding to a voltage including the reference voltage V_{ref} and the compensation voltage ΔV flows through the cathode electrode of the electron emission device 30.

In this case, the cathode current I_{CA} has a current value determined according to the reference voltage V_{ref} (a current value corresponding to the reference voltage V_{ref}+ the compensation voltage ΔV), so the anode current I_{A} can be controlled to be constant according to the reference voltage V_{ref}.

Meanwhile, in order to detect the compensation voltage ΔV for the gate current I_{G}, the electron emission device control apparatus according to an embodiment of the present disclosure can further include a gate current detector 60 for detecting a current flowing out through the gate electrode in the electron-emitting device 30, that is, the gate current I_{G}.

The gate current detector 60 can include various sensors as a current sensor for detecting the gate current I_{G}. For example, the gate current detector 60 can include a hole sensor or an MI current sensor using a magnetic field impedance effect. Alternatively, for the current sensor, it can be provided with a current sensor that includes a shunt resistor to detect a voltage drop due to the shunt resistor as a current. In the following description, for the sake of convenience of explanation, an example in which the gate current detector 60 detects the gate current as a voltage detected using the shunt resistor will be described.

However, the present disclosure is not, of course, limited thereto, and a magnitude of the gate current detected through the hole sensor or MI sensor can also, of course, be used. As an example, in the case of the hole sensor or MI sensor, the gate current can be directly detected without a shunt resistance, and in this case, assuming that there is a resistance (e.g., 1 ohm) having a preset value, a compensation voltage ΔV corresponding to the detected gate current can be determined.

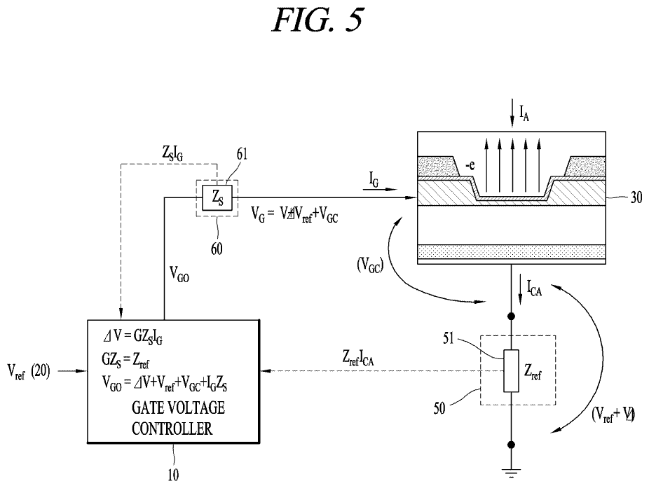

Hereinafter, the configuration of the electron emission device control apparatus according to an embodiment of the present disclosure, which can be applied in a case where the gate current I_{G} is not sufficiently small compared to the anode current I_{A}, will be described in more detail with reference to FIGS. 5 to 8 below.

Meanwhile, these days, with the development of technology, a gate device such as a MOSFET device that can operate at a low operating voltage and flow a large amount of current at a fast-operating speed, such as a MOSFET device has been introduced. Accordingly, the electron emission device 30 of the electron emission device control apparatus according to an embodiment of the present disclosure can be an electron emission device provided with the MOSFET device or a gate device corresponding to the MOSFET device, and configured to be turned on even at a low gate voltage. Therefore, the gate voltage of the electron emission device 30 can be more easily adjusted.

Hereinafter, the foregoing configuration and operation of the electron emission device control apparatus according to an embodiment of the present disclosure will be described in more detail through a plurality of conceptual diagrams and flowcharts.

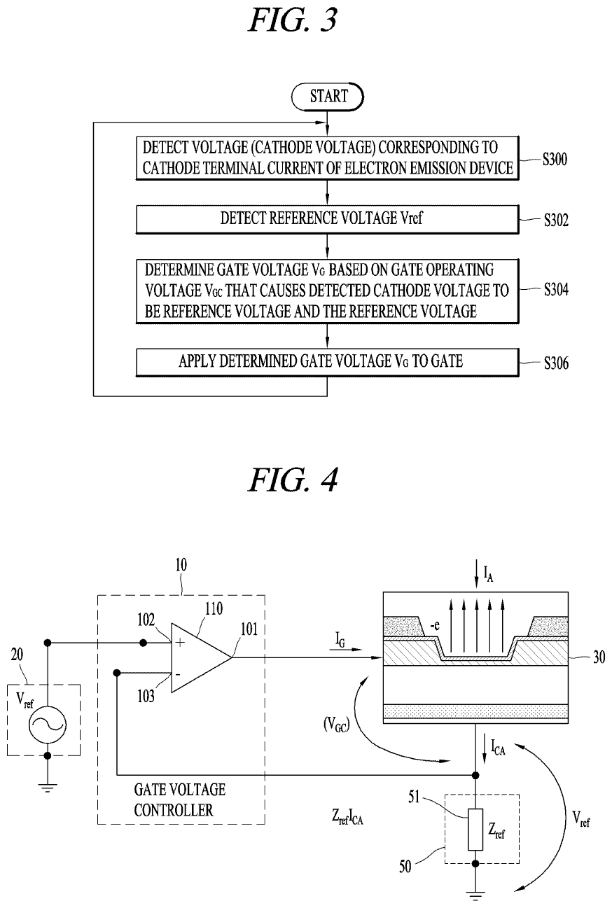

First, FIG. 2 is a diagram for explaining an electron emission device control apparatus according to an embodiment of the present disclosure, which can be applied in a case where the magnitude of the gate current I_{G} is sufficiently small compared to the anode current I_{A}. Furthermore, FIG. 3 is a flowchart showing an operation process of controlling a gate voltage to control an anode current in the electron emission device control apparatus as shown in FIG. 2.

Referring to FIGS. 2 and 3, first, the cathode current detector 50 can detect a current flowing through at least one cathode electrode of the electron emission device 30. Here, in a case where the cathode current detector 50 detects a current using a shunt resistance, the cathode current detector 50 can detect a voltage (cathode voltage V_{CA}) corresponding to the cathode current I_{CA} with a value obtained by multiplying the detection resistance Z_{ref} of the cathode current detector 50 by the cathode current I_{CA} (S300). Here, since the cathode current detection resistance Z_{ref} has a fixed value, the cathode current detection resistance Z_{ref} can be considered as a proportional constant of the cathode current detector 50 for the cathode current I_{CA}.

Meanwhile, when the cathode voltage is detected through the cathode current detector 50, the gate voltage controller 10 can detect the reference voltage V_{ref} generated by the reference voltage generator 20 (S302). Furthermore, the gate voltage V_{G} that causes the detected cathode voltage V_{CA} to be equal to the reference voltage V_{ref} can be determined (S304). Furthermore, the determined gate voltage V_{G} can be applied to the gate electrode of the electron emission device 30 (S306).

Here, the cathode voltage V_{CA} corresponds to a difference between the gate voltage V_{G} and the gate-cathode voltage V_{GC}. That is, the sum of the cathode voltage V_{CA} and the gate-cathode voltage V_{GC} becomes the gate voltage V_{G} (V_{CA}+V_{GC}=V_{G}), so the gate voltage V_{G} that causes the cathode voltage V_{CA} to be equal to the reference voltage V_{ref} can be a voltage greater than the reference voltage V_{ref} by the gate-cathode voltage V_{GC}, as shown in Equation 1 below.

$${V}_{G} = {V}_{G C} + {V}_{ref} \qquad [ Equation l ]$$

Here, V_{G} is a gate voltage, V_{GC} is a gate-cathode voltage, and V_{ref} is a reference voltage.

Therefore, when the gate voltage V_{G} according to Equation 1 is applied to the gate electrode of the electron emission device 30, a voltage required for electron emission from the cathode electrode, that is, a voltage higher than the gate-cathode voltage V_{GC} by the reference voltage V_{ref} is applied to the gate electrode, and electrons can be emitted from the cathode electrode. Furthermore, a voltage remaining after the electrons are emitted can be applied to the cathode electrode. That is, a voltage dropped from the gate voltage V_{G} by a voltage required for electron emission (gate-cathode voltage V_{GC}) can be applied to the cathode electrode, and accordingly, the reference voltage V_{ref} is applied to the cathode electrode. Therefore, the reference voltage V_{ref} can be the cathode voltage V_{CA} as shown in Equation 2 below.

$${V}_{ref} = {Z}_{ref} \cdot {I}_{CA} = {V}_{CA} ∴ {I}_{CA} = \frac{{Z}_{ref}}{{V}_{ref}} \qquad [ Equation 2 ]$$

Here, V_{ref} is a reference voltage, I_{CA} is a cathode current, and Z_{ref} is a proportional constant of the cathode current detector for the cathode current.

Meanwhile, since the cathode current I_{CA} has a relationship as shown in Equation 3 below, as assumed above, when the gate current I_{G} is sufficiently small compared to the anode current I_{A}, a relationship as shown in Equation 4 can be formed.

$${I}_{CA} = {I}_{A} + {I}_{G} \qquad [ Equation 3 ]$$

Here, I_{CA} is a cathode current, I_{A} is an anode current, and I_{G} is a gate current.

$${I}_{CA} = \frac{{Z}_{ref}}{{V}_{ref}} = \approx {I}_{A} [ if {I}_{A} ⪢ {I}_{G} ] \qquad [ Equation 4 ]$$

Here, I_{CA} is a cathode current, I_{A} is an anode current, I_{G} is a gate current, V_{ref} is a reference voltage, and Z_{ref} is a proportional constant of the cathode current detector for the cathode current.

Therefore, as assumed above, when the gate current I_{G} is sufficiently small compared to the anode current I_{A} so as to be negligible, the gate voltage controller 10 of the electron emission device control apparatus according to an embodiment of the present disclosure can adjust a gate voltage applied to the electron emission device 30 to adjust the anode current I_{A} to a current corresponding to the reference voltage V_{ref}. That is, the gate voltage controller 10 can control the anode current I_{A} by controlling the reference voltage generator 20 to control the reference voltage V_{ref}, and in this case, an amount of X-rays emitted from the electron emission device 30 is determined by the anode current I_{A}, so the gate voltage controller 10 can control the reference voltage generator 20 to adjust the amount of X-rays emitted from the electron emission device 30.

Meanwhile, the gate voltage controller 10 can be configured to include an operational amplifier so as to allow the cathode voltage V_{CA} to be equal to the reference voltage V_{ref}. FIG. 4 is an exemplary diagram showing a circuit configuration example of a gate voltage controller including an operational amplifier in an electron emission device control apparatus according to an embodiment of the present disclosure as described above.

Referring to FIG. 4, the operational amplifier 110 has a first input node 102 that receives a reference voltage, and a second input node 103 that receives a cathode voltage V_{CA}, that is, a voltage (Z_{ref}*I_{CA}) detected by the cathode current detector 50. Additionally, the gate voltage controller 10 can control a voltage of an output terminal 101 such that an input voltage of the first input node 102 is equal to an input voltage of the second input node 103. In this case, a voltage applied to the output terminal 101 can be the gate voltage V_{G} such that the input voltage of the first input node 102 is equal to the input voltage of the second input node 103. In this case, a difference between the gate voltage V_{G} and the reference voltage V_{ref} can be the gate-cathode voltage V_{GC}. That is, the gate-cathode voltage V_{GC} can be determined according to the cathode voltage V_{CA} and gate voltage V_{G} detected by the cathode current detector 50.

Meanwhile, the gate voltage controller 10 can be configured as a digital circuit utilizing a micro control unit (MCU). In addition, in the above description, an example in which the cathode current detector 50 uses a shunt resistor has been described, but the cathode current can, of course, be detected through a hole sensor or MI sensor. In this case, the proportional constant Z_{ref} of the cathode current detector 50 can be arbitrarily determined, and when assumed to be 1 ohm, the cathode current I_{CA} and the cathode voltage V_{CA} can have the same value.

Meanwhile, the electron emission device control apparatus according to the embodiment of the present disclosure described above in FIGS. 2 to 4 can determine the gate voltage V_{G} according to the pre-stored gate-cathode voltage V_{GC} and the preset reference voltage V_{ref} when initially controlling the electron emission device 30, that is, when there is no detected cathode current. Furthermore, when the cathode current is detected from the electron emission device 30 according to the determined gate voltage, the gate voltage V_{G} that causes the voltage corresponding to the detected cathode current to be equal to the reference voltage V_{ref} can be determined. Furthermore, the gate-cathode voltage V_{GC} can be determined according to a difference between the gate voltage V_{G} and the reference voltage V_{ref}. Therefore, when the initial gate-cathode voltage V_{GC} is a higher voltage than necessary due to the characteristics of the electron emission device 30, it can be changed to the gate-cathode voltage V_{GC} according to the characteristics of the electron emission device 30 in a subsequent process.

Meanwhile, FIGS. 2 to 4 described above assume a case where the gate current is sufficiently small compared to the anode current. However, there can be a case where the gate current does not satisfy the above condition.

As an example, as described above, when the electron emission device 30 uses a gate device such as a MOSFET device, the gate voltage can be sufficiently small compared to the anode voltage due to the characteristics of the MOSFET device that can operate even at a low gate current. However, when the electron emission device 30 does not use a gate device such as a MOSFET device, the gate current can be significantly large and can even have a value larger than the anode current. In this case, it is required to compensate for a voltage due to the gate current. FIGS. 5 to 8 below assume a case where the gate current is not so small as to be negligible compared to the anode current.

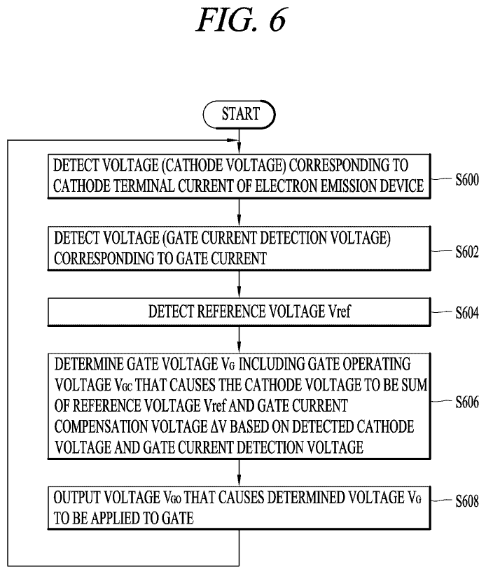

First, FIG. 5 is a conceptual diagram for explaining a configuration of an electron emission device control apparatus according to an embodiment of the present disclosure, which includes a configuration for compensating for the gate current according to the above-described assumption. Furthermore, FIG. 6 is a flowchart showing an operation process in which the electron emission device control apparatus according to the embodiment of the present disclosure shown in FIG. 5 controls a gate voltage to control an anode current.

Referring to FIGS. 5 and 6, first, the cathode current detector 50 can detect a current flowing through at least one cathode electrode of the electron emission device 30. Here, in a case where the cathode current detector 50 detects a current using a shunt resistance, the cathode current detector 50 can detect a voltage (cathode voltage V_{CA}) corresponding to the cathode current I_{CA} with a value Z_{ref}*I_{CA} obtained by multiplying the detection resistance Z_{ref} of the cathode current detector 50 by the cathode current I_{CA} (S600). Here, since the cathode current detection resistance Z_{ref} has a fixed value, the cathode current detection resistance Z_{ref} can be considered as a proportional constant of the cathode current detector 50 for the cathode current I_{CA}.

Meanwhile, when a voltage corresponding to the cathode current is detected through the cathode current detector 50, the gate voltage controller 10 can detect the gate current I_{G} flowing from the gate electrode of the electron emission device 30 to the cathode electrode through the gate current detector 60 (S602). Here, the gate current I_{G} can be a current applied to the gate electrode of the electron emission device 30.

Here, in a case where the gate current detector 60 detects a current using a shunt resistor, the gate current detector 60 can detect a voltage corresponding to the gate current I_{G} with a value Z_{S}*I_{G} obtained by multiplying the detection resistance Z_{S} of the gate current detector 60 by the gate current I_{G} (S600). Here, since the gate current detection resistance Z_{S} has a fixed value, the gate current detection resistance Z_{S} can be considered as a proportional constant of the gate current detector 60 for the gate current I_{G}.

Meanwhile, when a cathode voltage is detected through the cathode current detector 50 and a voltage corresponding to the gate current is detected through the gate current detector 60, the gate voltage controller 10 can detect the reference voltage V_{ref} generated by the reference voltage generator 20 (S604). Furthermore, the gate voltage controller 10 can determine the gate voltage V_{G} that causes the cathode voltage (V_{CA}=Z_{ref}*I_{CA}) detected in the step S600 to be a sum voltage (V_{ref}+ΔV) of the detected reference voltage V_{ref} and the compensation voltage ΔV due to the gate current I_{G} (S606).

Here, the compensation voltage ΔV due to the gate current I_{G}, which is a voltage proportional to the gate current I_{G} to compensate for the gate current I_{G}, has a value proportional to a detection value of the gate current detector 60 (a voltage value corresponding to the gate current) Z_{S}*I_{G} as shown in Equation 5 below.

$$△ V = G \cdot {Z}_{S} \cdot {I}_{G} \qquad [ Equation 5 ]$$

Here, ΔV is a compensation voltage according to a gate current, Z_{S} is a proportional constant of the gate current detector 60, I_{G} is a gate current, and G is a proportional constant of the compensation voltage ΔV and a detection value (Z_{S}*I_{G}) of the gate current detector.

Here, the proportional constant G of the compensation voltage ΔV and the detection value (Z_{S}*I_{G}) of the gate current detector 60 is a ratio (G=Z_{ref}/Z_{S}) of a resistance value (proportional constant Z_{ref}) of the cathode current detector 50 with respect to a resistance value (proportional constant Z_{S}) of the gate current detector 60, so the compensation voltage ΔV can be expressed as a product (Z_{ref}*I_{G}) of the resistance value (proportional constant Z_{ref}) of the cathode current detector 50 and the gate current I_{G}.

Therefore, the sum voltage (V_{ref}+ΔV) of the reference voltage V_{ref} and the compensation voltage ΔV can be a voltage obtained by adding the reference voltage V_{ref} to the product (Z_{ref}*I_{G}) of the proportional constant Z_{ref} of the cathode current detector 50 and the gate current I_{G}, that is, V_{ref}+Z_{ref}*I_{G}.

Meanwhile, in the step S606, the gate voltage controller 10 allows the cathode voltage (V_{CA}=Z_{ref}*I_{CA}) to be a sum voltage (V_{ref}+ΔV) of the reference voltage V_{ref} and the compensation voltage ΔV, so it can be expressed as Equation 6 below.

$${Z}_{ref} \cdot {I}_{CA} = {V}_{ref} + {Z}_{ref} \cdot {I}_{G} ∴ {I}_{CA} = {I}_{G} + \frac{{V}_{ref}}{{Z}_{ref}} \qquad [ Equation 6 ]$$

Here, Z_{ref} is a proportional constant of the cathode current detector 50, I_{CA} is a cathode current, V_{ref} is a reference voltage, and I_{G} is a gate current.

Meanwhile, according to Equation 3, the cathode current I_{CA} is a sum of the gate current I_{G} and the anode current I_{A}, so the anode current I_{A} can be determined as V_{ref}/Z_{ref}, that is, a magnitude of the reference voltage V_{ref} with respect to a fixed resistance (proportional constant Z_{ref}) of the cathode current detector 50 according to Equation 6 and Equation 3.

Therefore, the gate voltage controller 10 of the electron emission device control apparatus according to an embodiment of the present disclosure can adjust a gate voltage applied to the electron emission device 30 to adjust the anode current I_{A} to a current according to the reference voltage V_{ref}. That is, the gate voltage controller 10 can control the anode current I_{A} by controlling the reference voltage generator 20 to control the reference voltage V_{ref}, and in this case, an amount of X-rays emitted from the electron emission device 30 is determined by the anode current I_{A}, so the gate voltage controller 10 can control the reference voltage generator 20 to adjust the amount of X-rays emitted from the electron emission device 30.

Meanwhile, the gate voltage controller 10 can output a voltage such that the gate voltage V_{G} determined in the step S606 is applied to the gate electrode of the electron emission device 30 (S608). In this case, a voltage V_{GO} output from the gate voltage controller 10 can be determined in consideration of a voltage dropped in the gate current detector 60 for gate current detection. Therefore, in the step S608, the gate voltage controller 10 can output a voltage greater than the gate voltage V_{G} determined in the step S606 by a voltage dropped in the gate current detection unit 60, that is, a voltage (Z_{S}*I_{G}) corresponding to the gate current.

Meanwhile, the electron emission device control apparatus according to the embodiment of the present disclosure described in FIGS. 5 and 6 can also determine the gate voltage V_{G} according to the pre-stored gate-cathode voltage V_{GC} and compensation voltage ΔV, the proportional constant Z_{S} of the gate current detector 60 and the gate current I_{G}, and the preset reference voltage V_{ref} when initially controlling the electron emission device 30, that is, when there is no detected cathode current.

Furthermore, when the cathode current is detected from the electron emission device 30 according to the determined gate voltage, the gate voltage V_{G} that causes a voltage (Z_{ref}*I_{CA}) corresponding to the detected cathode current to be equal to a sum voltage (V_{ref}+ΔV) of the reference voltage V_{ref} and the compensation voltage ΔV can be determined. Furthermore, the gate-cathode voltage V_{GC} can be determined according to a difference between the gate voltage V_{G} and the sum voltage (V_{ref}+ΔV). Therefore, when the initial gate-cathode voltage V_{GC} is a higher voltage than necessary due to the characteristics of the electron emission device 30, it can be changed to the gate-cathode voltage V_{GC} according to the characteristics of the electron emission device 30 in a subsequent process.

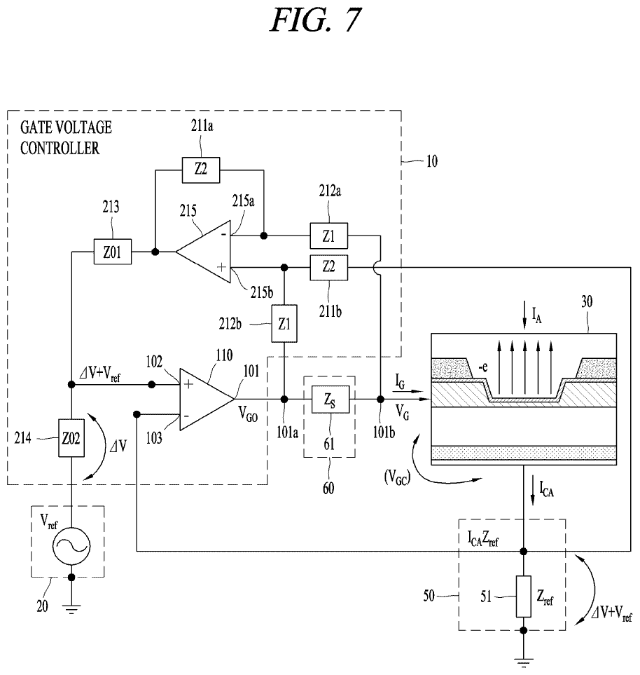

Meanwhile, FIG. 7 is an exemplary diagram showing a circuit configuration example of the gate voltage controller 10 that controls a gate voltage in the electron emission device control apparatus shown in FIG. 5.

Referring to FIG. 7, the gate voltage controller 10 that generates the gate voltage can include a first input node 102 that receives a reference voltage V_{ref} and a compensation voltage ΔV and a second input node 103 that receives an output voltage (Z_{ref}*I_{CA}) of the cathode current detector 50, and include a first operational amplifier 110 in which a voltage of the output terminal 101 is controlled such that the voltages input to the first input node 102 and the second input node 103 are equal to each other.

Here, a first resistor 214 having a resistance value Z02 for generating the compensation voltage ΔV can be provided between the reference voltage generator 20 and the first input node 102, which are connected to each other to receive the reference voltage.

Meanwhile, a detection resistor Z_{S} of the gate current detector 60 for detecting the gate current can be provided between the output terminal 101 of the first operational amplifier 110 and the electron emission device 30. Furthermore, between both ends of the detection resistor Z_{S}, a second node 101b connected to the electron emission device 30 can be connected to a first input node 215a of a second operational amplifier 215 for gate current compensation, and a second resistor 212a having a resistance value Z1 can be provided between the second node 101b and the first input node 215a.

Meanwhile, between both ends of the detection resistor Z_{S}, a first node 101a connected to the output terminal 101 of the first operational amplifier 110 can be connected to a second input node 215b of the second operational amplifier 215. Additionally, a third resistor 212b having a resistance value Z1 can be provided between the first node 101a and the second input node 215b of the second operational amplifier 215.

Here, the second input node 215b of the second operational amplifier 215 can be connected to the cathode current detector 50 to receive a detection voltage of the cathode current detector 50. In this case, a fourth resistor 211b having a resistance value Z2 can be provided between the second input node 215b of the second operational amplifier 215 and the cathode current detector 50.

Meanwhile, the first input node 215a of the second operational amplifier 215 can be connected to an output terminal of the second operational amplifier 215. In this case, a fifth resistor 211a having a Z2 value can be provided between the first input node 215a of the second operational amplifier 215 and the output terminal of the second operational amplifier 215. Furthermore, the output terminal of the second operational amplifier 215 can be connected to the first input node 102 of the first operational amplifier 110. In this case, a sixth resistor 213 having a value of Z01 can be provided between the output terminal of the second operational amplifier 215 and the first input node 102 of the first operational amplifier 110.

Here, the first to sixth resistors 214, 212a, 212b, 211a, 211b, 213 can be used to adjust the amplification gains of the first operational amplifier 110 and the second operational amplifier 215. Furthermore, a voltage input to the first input node 102 of the first operational amplifier 110 and a voltage applied to the second input node 103 can be equal to each other by the second resistor 212a and the third resistor 212b having the Z1 value, the fourth resistor 211a and the fifth resistor 211b having the Z2 value, the first resistor 213 and the sixth resistor 214 having the Z01 value. In this case, the compensation voltage ΔV can have a relationship for the resistance values (Z01, Z1, Z2) as shown in Equation 7 below.

$$△ V = G \cdot {Z}_{S} \cdot {I}_{G} = \frac{{Z}_{02} \cdot {Z}_{2}}{{Z}_{01} \cdot {Z}_{1}} \cdot {Z}_{S} \cdot {I}_{G} ∴ G = \frac{{Z}_{02} \cdot {Z}_{2}}{{Z}_{01} \cdot {Z}_{1}} \qquad [ Equation 7 ]$$

$$Here , when$$

$$\frac{{Z}_{02} \cdot {Z}_{2}}{{Z}_{01} \cdot {Z}_{1}} \cdot {Z}_{S}$$

is set to the detection resistance Z_{ref} of the cathode current detector 50, the compensation voltage ΔV becomes Z_{ref}*I_{G}, so the cathode voltage V_{CA} can be V_{ref}+ΔV.

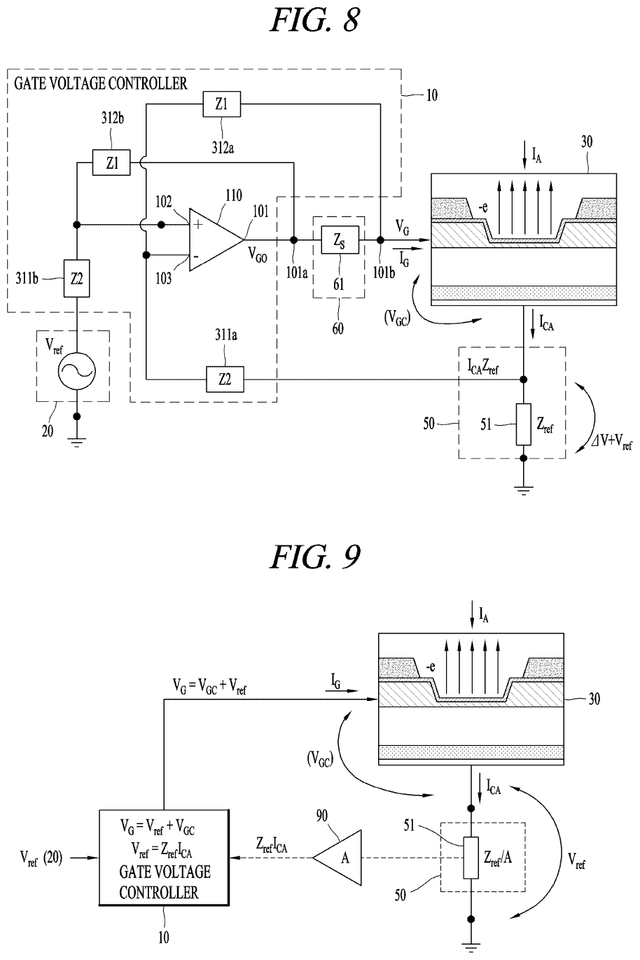

FIG. 8 is an exemplary diagram showing a different circuit configuration example of the gate voltage controller 10 that controls a gate voltage in the electron emission device control apparatus shown in FIG. 5.

Referring to FIG. 8, the gate voltage controller 10 that generates the gate voltage can include a first input node 102 that receives a reference voltage V_{ref} and a compensation voltage ΔV and a second input node 103 that receives an output voltage (Z_{ref}*I_{CA}) of the cathode current detector 50, and include a first operational amplifier 110 in which a voltage of the output terminal 101 is controlled such that the voltages input to the first input node 102 and the second input node 103 are equal to each other.

Here, a first resistor 311b having a resistance value Z2 for generating the compensation voltage ΔV can be provided between the reference voltage generator 20 and the first input node 102, which are connected to each other to receive the reference voltage. Furthermore, a second resistor 311b having a resistance value Z2 can be provided between the second input node 103 and the cathode current detector 50 connected thereto.

Meanwhile, a detection resistor Z_{S} of the gate current detector 60 for detecting the gate current can be provided between the output terminal 101 of the first operational amplifier 110 and the electron emission device 30. Furthermore, between both ends of the detection resistor Z_{S}, a second node 101b connected to the electron emission device 30 can be connected to the second input node 103, and a third resistor 312a having a resistance value Z1 can be provided between the second node 101b and the first input node 103.

Meanwhile, between both ends of the detection resistor Z_{S}, a first node 101a connected to the output terminal 101 of the first operational amplifier 110 can be connected to the second input node 102. Furthermore, a fourth resistor 312b having a resistance value Z1 can be provided between the first node 101a and the first input node 102.

In this case, a voltage (Z_{S}*I_{G}) detected by the gate current detector 60 can be input to the first node 101a and the second node 102b) at both ends of the detection sensor Z_{S}. Then, a voltage input to the first node 101a can be adjusted by the fourth resistor 312b having a Z1 value and the first resistor 311b having a Z2 value to be input to the first input node 102 of the first operational amplifier 110. Furthermore, a voltage input to the second node 101b can be adjusted by the third resistor 312a having a Z1 value and the second resistor 311a having a Z2 value to be input to the second input node 103 of the first operational amplifier 110. Furthermore, the first operational amplifier 110 can adjust the voltage of the output terminal 101 such that the cathode voltage becomes V_{ref}+ΔV to output the gate voltage V_{G}. Here, the compensation voltage ΔV can have a relationship for the resistance values Z1, Z2 as shown in Equation 8 below.

$$△ V = G \cdot {Z}_{S} \cdot {I}_{G} = \frac{{Z}_{2}}{{Z}_{1}} \cdot {Z}_{S} \cdot {I}_{G} ∴ G = \frac{{Z}_{2}}{{Z}_{1}} \qquad [ Equation 8 ]$$

$$Here , when$$

$$\frac{{Z}_{2}}{{Z}_{1}} \cdot {Z}_{S}$$

is set to the detection resistance Z_{ref} of the cathode current detector 50, the compensation voltage ΔV becomes Z_{ref}*I_{G}, so the cathode voltage V_{CA} can be V_{ref}+ΔV.

Meanwhile, as described above, the gate voltage controller 10 of the electron emission device control apparatus according to an embodiment of the present disclosure detects the cathode voltage and applies a voltage greater than the detected cathode voltage by the gate-cathode voltage as a gate voltage to the electron emission device 30 so as to control the anode current constant. Therefore, when the detected cathode voltage is greater than the gate-cathode voltage V_{GC}, there can be a problem in that a voltage greater than the required gate-cathode voltage V_{GC} must be applied to a gate of the electron emission device 30.

The anode current I_{A} of the electron emission device 30 can be proportional to the gate current I_{G}. In this case, the anode current I_{A} and the gate current I_{G} can be shown as Equation 9 below.

$${I}_{A} = β \cdot {I}_{G} \qquad [ Equation 9 ]$$

Here, I_{A} is the anode current, I_{G} is the gate current, and β is a proportional constant.

In this case, when the electron emission device 30 has characteristics in which the anode current is greater than or equal to the gate current (I_{A}≤I_{G}), and the proportional constant β is less than 1, for example, when the anode current I_{A} is 0.02 A and the proportional constant β is 0.01, the gate current I_{G} can be calculated as 2 A according to Equation 9.

In this case, the cathode current I_{CA} can be calculated as a sum of the gate current I_{G} and the anode current I_{A}, so the cathode current I_{CA} can be 2.02 A. Meanwhile, when the resistance value Z_{ref} of the cathode current detector 50 is 20 ohm, the cathode current detection unit 50 can output 40.4 V obtained by multiplying the cathode current I_{CA} of 2.02 A by the resistance value Z_{ref} of 20 ohm as a detection voltage corresponding to the cathode current I_{CA}.

Meanwhile, when the gate-cathode voltage V_{GC} is 10 V, the gate-cathode voltage V_{GC} of 10 V is added to the detection voltage of the cathode current detector 50, which is 40.4 V, to set a total gate voltage V_{G} to 50.4 V, and the set gate voltage V_{G} can be applied to the gate electrode of the electron emission device 30.

However, as described above, when a gate voltage V_{G} higher than the gate-cathode voltage V_{GC} is applied, the electron emission device 30 can be turned on to generate electron emission from the cathode electrode. That is, when the gate-cathode voltage V_{GC} having a voltage of above 10 V is applied as the gate voltage, the electron emission device 30 can be turned on, but when a detection value of the cathode current detector 50 is high, the gate voltage can be higher than necessary due to the high detection value of the cathode current detection unit 50. Therefore, the electron emission device 30 can be driven at an unnecessarily high gate voltage, and in this case, a system based on high-voltage protection design, such as high-voltage stress, can be required.

Accordingly, the cathode current detector 50 of the electron emission device control apparatus according to an embodiment of the present disclosure can further include an amplifier capable of amplifying a voltage applied to the detection resistance (proportional constant Z_{ref}).

FIG. 9 is a conceptual diagram for explaining a configuration of an electron emission device control apparatus according to an embodiment of the present disclosure, which further includes an amplifier 90 capable of amplifying a cathode current detection voltage as described above.

In this case, when a voltage applied to the detection resistance Z_{ref} is amplified through the amplifier, the cathode current detector 50 can detect a cathode current according to the amplified voltage applied to the detection resistance Z_{ref}. Therefore, in order to maintain the characteristics of the cathode current I_{CA}, a magnitude of the detection resistance Z_{ref}, that is, a proportional constant Z_{ref} of the cathode current detector 50 with respect to the cathode current I_{CA}, can be reduced. Therefore, a voltage corresponding to the cathode current I_{CA} is detected and output (Z_{ref}*I_{CA}) according to a product of the reduced proportional constant Z_{ref} and the cathode current I_{CA}, and thus the problem of the gate voltage being determined to be higher than necessary can be solved.

For example, as in the foregoing assumption, in a case where the anode current I_{A} is 0.02 A, the gate current I_{G} is 2 A (and therefore the cathode current is 2.02 A), and the resistance value Z_{ref} of the cathode current detector 50 is 20 ohm, on the assumption that the amplification gain A of the amplifier 90 is 100, in order to maintain the characteristics of the cathode current I_{CA}, the detection resistance of the cathode current detector 50, that is, a magnitude of the proportional constant Z_{ref}, can be reduced by 1/100 to 0.2 (Z_{ref}=0.2 ohm).

Then, the voltage V_{CA} corresponding to the cathode current I_{CA} detected by the cathode current detector 50 becomes 0.2*2.02=0.404 V, and in this case, when the gate-cathode voltage V_{GC} is 10 V, the gate voltage controller 10 can determine the gate voltage V_{G} to be 10+0.404, that is, 10.404 V. That is, it can be seen that the gate voltage of the electron emission device 30 can be determined at a voltage close to the gate-cathode voltage V_{GC}, which is a turn-on voltage.

In this case, in consideration of an efficiency of the electron emission device 30, that is, a power consumption between the gate and the ground, the power consumption (W) between the gate and the ground can be calculated as a sum of a gate power consumption and a power consumption of the cathode current detector 50.

Here, the gate power consumption can be calculated according to the gate-cathode voltage V_{CG} and the gate current I_{G}, so in the case of the foregoing assumption, the gate power consumption is 10*2=20 W, and therefore, a case in which the amplifier 90 is employed can be the same as that in which the amplifier 90 is not employed.

However, when comparing the power consumption of the cathode current detector 50, first, in the case in which the amplifier 90 is not employed, the power consumption of the cathode current detector 50 is calculated as a square of the current (cathode current I_{CA}) and the resistance value Z_{ref}, (2.02 A)²*20 ohm, that is, 81.6 W, and thus can be calculated as 101.6 W in consideration of the gate power consumption. On the contrary, when the amplifier 90 is employed, the power consumption of the cathode current detector 50 is calculated as a square of the current (cathode current I_{CA}) and the resistance value Z_{ref}, (2.02 A) 2*0.02 ohm, that is, 0.08 W, and thus can be calculated as 20.8 W in consideration of the gate power consumption. That is, it can be seen that the efficiency of the electron emission device 30 can be greatly improved when the amplifier 90 is employed.

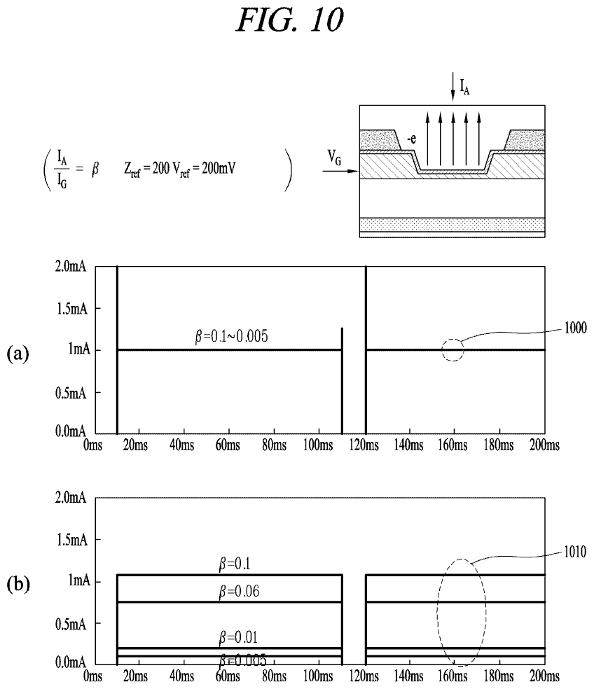

Meanwhile, FIG. 10 shows examples of an anode current controlled by the electron emission device control apparatus, wherein (a) of FIG. 10 shows an example of the anode current controlled in the electron emission device control apparatus according to an embodiment of the present disclosure, and (b) of FIG. 10 shows an example of the anode current controlled in a typical electron emission device control apparatus. In (a) and (b) of FIG. 10, it is assumed that a detection resistance of the cathode current detector 50, that is, a detection voltage proportional constant Z_{ref} of the cathode current detector 50 for a cathode current is 200 mohm, and a reference voltage V_{ref} is 200 mV.

First, referring to (a) of FIG. 10, in the case of the electron emission device control apparatus to which the present disclosure is applied, as shown in Equation 6 above,

$${I}_{CA} = {I}_{G} + \frac{{V}_{ref}}{{Z}_{ref}} ,$$

and therefore, the anode current can be fixed according to a ratio of the reference voltage V_{ref} to the detection voltage proportional constant Z_{ref} of the cathode current detector 50. That is, a magnitude of the anode current I_{A} can be fixed by V_{ref}/Z_{ref} regardless of the electron emission device characteristic (β) of the gate current I_{G} with respect to the anode current I_{A}. Therefore, as shown in (a) of FIG. 10, even when the electron emission device characteristic (B) varies from 0.005 to 0.1, the magnitude of the anode current I_{A} can be fixed (1000), and accordingly, the amount of X-rays generated can be constant regardless of the electron emission device characteristic (β).

However, when the present disclosure is not applied, the anode current I_{A} and the gate current I_{G} have a relationship as shown in Equation 9. Therefore, as shown in (b) of FIG. 10, for the same gate current I_{G}, the anode current I_{A} can vary depending on the characteristic (B) of the electron emission device. That is, as in the foregoing example, when the electron emission device characteristic (B) varies from 0.005 to 0.1, the anode current I_{A} can vary (1010). Therefore, a problem can arise that the amount of X-rays generated varies depending on the characteristics (β) of the electron emission device.

The foregoing control method of the present disclosure can be implemented as computer-readable codes on a program-recorded medium. The computer-readable medium can include any type of recording device in which data readable by a computer system is stored. Examples of the computer-readable media can include a hard disk drive (HDD), a solid-state disk (SSD), a silicon disk drive (SDD), a ROM, a RAM, a CD-ROM, a magnetic tape, a floppy disk, and an optical data storage device, and the like, and also include a device implemented in the form of a carrier wave (for example, transmission via the Internet). The above detailed description is therefore to be construed in all aspects as illustrative and not restrictive. The scope of the present disclosure should be determined by reasonable interpretation of the appended claims and all changes that come within the equivalent scope of the present disclosure are included in the scope of the present disclosure.

1. A control apparatus of an electron emission device, the control apparatus comprising:
the electron emission device comprising at least one cathode electrode, an anode electrode paired with the cathode electrode, and at least one gate electrode for controlling a current flowing through the anode electrode;
a cathode current detector that detects a current flowing through the cathode electrode of the electron emission device;
a reference voltage generator that generates a reference voltage; and
a gate voltage controller that receives the reference voltage and the detection voltage of the cathode current detector, determines a gate voltage for controlling the electron emission device such that the detection voltage of the cathode current detector is equal to the reference voltage, and applies the determined gate voltage to the gate electrode of the electron emission device.

2. The control apparatus of claim 1, wherein the gate voltage controller determines a voltage greater than the reference voltage by a gate-cathode voltage formed between the gate electrode and the cathode electrode as the gate voltage, and
wherein the gate-cathode voltage is a voltage threshold required for electron emission from the cathode electrode.

3. The control apparatus of claim 1, wherein the current flowing through the anode electrode is a current corresponding to the reference voltage when the current flowing through the anode electrode and the current flowing through the gate electrode satisfy a preset condition.

4. The control apparatus of claim 1, further comprising:
a gate current detector for detecting a gate current flowing through the gate electrode in the electron emission device,
wherein the gate voltage controller determines a gate voltage for controlling the electron emission device such that the detection voltage of the cathode current detector is equal to a sum of the reference voltage and a compensation voltage for the gate current, and
wherein the compensation voltage is determined according to a detection resistance Z_{ref} of the cathode current detector for the current flowing through the cathode electrode and a magnitude of the gate current.

5. The control apparatus of claim 4, wherein a gate voltage that causes the detection voltage of the cathode current detector to be equal to the sum of the reference voltage and the compensation voltage is determined as a voltage greater than the detection voltage by a voltage that is a sum of the compensation voltage, a gate-cathode voltage formed between the gate electrode and the cathode electrode, and the detection voltage of the gate current detector.

6. The control apparatus of claim 5, wherein the current flowing through the anode electrode is determined according to a magnitude of the reference voltage with respect to the detection resistance Z_{ref} of the cathode current detector.

7. The control apparatus of claim 4, wherein the cathode current detector and the gate current detector is each any one of a hole sensor, a magneto impedance (MI) current sensor, and a current sensor that detects a voltage dropped by a shunt resistance as a current.

8. The control apparatus of claim 1, wherein the cathode current detector further comprises an amplifier for amplifying a voltage applied to a detection resistance of the cathode current detector, and
wherein the gate voltage controller determines the gate voltage based on a detection voltage of the cathode current detector, which is detected based on a detection resistance relatively lowered by an amplification gain of the amplifier.

9. A control method of a control apparatus for controlling an electron emission device that generates X-rays through electrons emitted through at least one cathode electrode, the control method comprising:
detecting a cathode voltage corresponding to a current flowing through the cathode electrode;
detecting a reference voltage; determining a gate voltage such that the cathode current detection voltage is equal to the reference voltage based on a gate-cathode voltage, which is a voltage between a gate electrode of the electron emission device and the cathode electrode, and the reference voltage; and
applying the determined gate voltage to the electron emission device to control the electron emission device such that a current corresponding to the reference voltage flows through the cathode electrode as the gate-cathode voltage drops through the electron emission.

10. The control method of claim 9, wherein the gate-cathode voltage is a voltage threshold required for electron emission from the cathode electrode.

11. The control method of claim 9, wherein a current flowing through an anode electrode of the electron emission device is a current corresponding to the reference voltage when the current flowing through the anode electrode and a current flowing through the gate electrode satisfy a preset condition.

12. The control method of claim 9, wherein the detecting of the reference voltage further comprises detecting a gate current flowing through the gate electrode,
wherein the determining of the gate voltage comprises determining a gate voltage for controlling the electron emission device such that the cathode voltage is equal to a sum of a compensation voltage for the gate current and the reference voltage, and
wherein the compensation voltage is determined according to a magnitude of the gate current and a detection resistance Z_{ref} for detecting the cathode voltage from the cathode current.

13. The control method of claim 12, wherein a gate voltage that causes the cathode voltage to be equal to the sum of the reference voltage and the compensation voltage is determined as a voltage greater than the detection voltage by a voltage that is a sum of the compensation voltage, the gate-cathode voltage, and a detection voltage corresponding to the gate current.

14. The control method of claim 9, wherein the detecting of the cathode voltage further comprises amplifying a voltage applied to a detection resistance Z_{ref} for detecting a current flowing through the cathode electrode as the cathode voltage, and
wherein the determining of the gate voltage comprises determining the gate voltage based on the cathode voltage detected based on the detection resistance relatively lowered by an amplification gain.

15. The control method of claim 12, wherein a current flowing through an anode electrode of the electron emission device is determined according to a magnitude of the reference voltage with respect to the detection resistance Z_{ref} for detecting a current flowing through the cathode electrode as the cathode voltage.
